(19) United States
(12) Patent Application Publication
(10) Pub. No.: US 2006/0015284 A1
(43) Pub. Date: Jan. 19, 2006

(54) Contaminant detecting touch sensitive element

(76) Inventors: Charles David Fry, New Bloomfield, PA (US); Simon Boutin, Toronto (CA)

Correspondence Address: Michael J. Aronoff;Tyco Electronics Corporation, Suite 140, 4550 New Linden Hill Road, Wilmington, DE, 19808, US

(21) Appl. No.: 10/891,610

(22) Filed: Jul. 15, 2004

(51) Int. Cl. G01D 1/00

(52) U.S. Cl. 702/127

(57) ABSTRACT

A touch sensitive control interface for a controlled device includes a panel defining an interface area configured to selectively input command instructions of an operator of the device. The panel has at least one primary touch portion configured to receive a true operator command, and a second touch sensor portion proximate the primary touch sensor portion configured to detect a false operator command due to a presence of a contaminant.

### BACKGROUND OF THE INVENTION

This invention relates generally to touch sensitive control interfaces, and more particularly, to touch sensor elements for environments vulnerable to spills and contaminants.

Due to their convenience and reliability, touch sensitive control interfaces are increasingly being used in lieu of mechanical switches for various products and devices. Touch sensitive control interfaces are used in a wide variety of exemplary applications such as appliances (e.g., stoves and cooktops), industrial devices such as machine controls, cash registers and check out devices, and even toys. The associated devices may be operated by pressing predefined areas of the interface with a finger, and typically include a controller coupled to the interface to operate mechanical and electrical elements of the device in response to user commands entered through the touch control interface.

Various types of touch technologies are available for use in touch control interfaces, including but not limited touch sensitive elements such as capacitive sensors, membrane switches, and infra-red detectors. It has been noted, however, that such touch sensitive elements are subject to inadvertent activation attributable to a foreign object or deposit that touches the interface in the vicinity of the touch sensitive elements. It has been observed, for example, that foreign materials splashed, spilled, deposited or otherwise accidentally applied to the control interface can actuate known touch sensitive elements. This is a particularly undesirable result when the touch sensitive elements are associated, for example, with an appliance heating element or a heavy piece of machinery, yet such splashes, spills, and unintentional application of foreign material are not uncommon to cooking environments and manufacturing environments.

U.S. Pat. No. 5,760,715 (the '715 patent) describes one system which is designed to avoid erroneous activation of a touch sensitive element due to foreign objects or deposits. The '715 patent describes a capacitive circuit formed through the touch sensitive element, the user, and the earth, and when the circuit is completed by a user a varying electric potential in the circuit triggers activation of the element and signals the controller to respond appropriately.

Despite safeguards of a system such as that described in the '715 patent, substances splashed, spilled or otherwise applied to the touch sensitive interface may nonetheless activate a touch sensitive element without a conscious action of a user. For example, a spilled condiment such as ketchup has been observed to extend and distort the effective activation area of one or more touch sensitive elements of a control interface. Thus, when the interface is coated with ketchup, a touch outside the normal operating area of the touch sensitive element may be transmitted through the ketchup to the normal activation area and actuate an associated component or device. That is, a user may touch an area or region of the control interface that in a normal condition would not activate the touch sensitive element, but because of the presence of the ketchup or other foreign matter which does touch the normal activation region of the touch sensitive element, the touch sensitive element may nonetheless be activated. As such, the likelihood of an inadvertent actuation of a touch sensitive element may be greatly increased by the presence of such a spill on the interface. When the user attempts to wipe the ketchup from the interface, affected touch sensitive elements may be unintentionally activated.

### BRIEF DESCRIPTION OF THE INVENTION

In an exemplary embodiment, a touch sensitive control interface for a controlled device is provided. The control interface comprises a panel defining an interface area configured to selectively input command instructions of an operator of the device. The panel comprises at least one primary touch sensor portion configured to receive a true operator command, and a secondary touch sensor portion proximate the activation area configured to detect a false operator command, for example, due to a presence of a contaminant.

In another exemplary embodiment, a touch sensitive control interface is provided. The interface comprises a plurality of touch sensitive areas configured to accept a user input. At least one of the touch sensitive areas comprises a primary activation area and a contaminant detection area surrounding the primary activation area.

In yet another exemplary embodiment, a touch sensitive control system for controlling a device is provided. The control system comprises an interface comprising at least one predefined primary touch sensitive activation area and a contaminant detection area adjacent the activation area, and a controller electrically connected to the interface and operatively responsive to the interface when the primary activation area is activated and when the contaminant detection are is not activated. The controller is programmed to prevent actuation of the device when the contaminant detection area is activated, regardless of the state of the primary activation area.

### BRIEF DESCRIPTION OF THE DRAWINGS

FIG. 1 is a schematic block diagram of an exemplary touch sensitive control system for a device.

FIG. 2 is a top plan view of an exemplary control interface for the control system shown in FIG. 1.

FIG. 3 is an exemplary control algorithm executable by the control system shown in FIG. 1.

FIG. 4 is a top plan view of another embodiment of a control panel for the control system shown in FIG. 1.

FIG. 5 is a top plan view of still another embodiment of a control panel for the control system shown in FIG. 1.

### DETAILED DESCRIPTION OF THE INVENTION

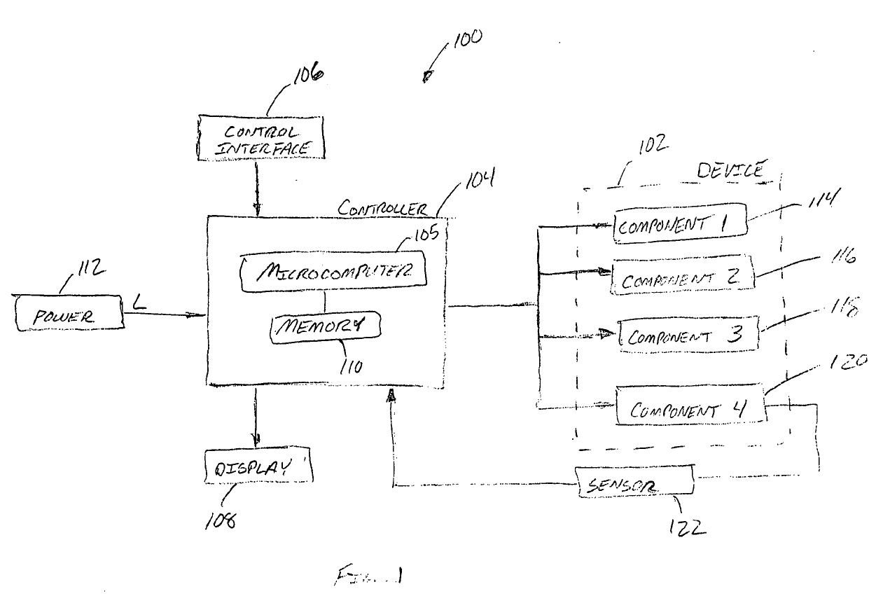

FIG. 1 is a schematic block diagram of an exemplary touch sensitive control system 100 for a device 102, which in various embodiments may be an appliance, an industrial machine or any other device in which a touch sensitive control interface is desirable, and for which inadvertent actuation of the device 102 is a concern.

In an exemplary embodiment, the control system 100 includes a controller 104 which may, for example, include a microcomputer or other processor 105 coupled to a user control interface 106 including one or more touch sensitive elements as described further below. An operator may enter control parameters, instructions, or commands and select desired operating algorithms and features of the device 102 via user interface input 106. In one embodiment a display or indicator 108 is coupled to the controller 104 to display appropriate messages and/or indicators to the operator of the device 102 to confirm user inputs and operation of the device 102. A memory 110 is also coupled to the controller 104 and stores instructions, calibration constants, and other information as required to satisfactorily complete a selected user instruction or input. Memory 110 may, for example, be a random access memory (RAM). In alternative embodiments, other forms of memory could be used in conjunction with RAM memory, including but not limited to flash memory (FLASH), programmable read only memory (PROM), and electronically erasable programmable read only memory (EEPROM).

Power to control system 100 is supplied to controller 104 by a power supply 112 configured to be coupled to a power line L. Analog to digital and digital to analog converters (not shown) are coupled to the controller 104 to implement controller inputs and executable instructions to generate controller outputs to operative components 114, 116, 118 and 120 of the device 102 according to known methods. While four components 114, 116, 118, and 120 are illustrated in FIG. 1, it is recognized that greater or fewer components may be employed within the scope of the present invention.

In response to manipulation of the control interface 106, the controller 104 monitors various operational factors of the device 102 with one or more sensors or transducers 122, and the controller 104 executes operator selected functions and features according to known methods.

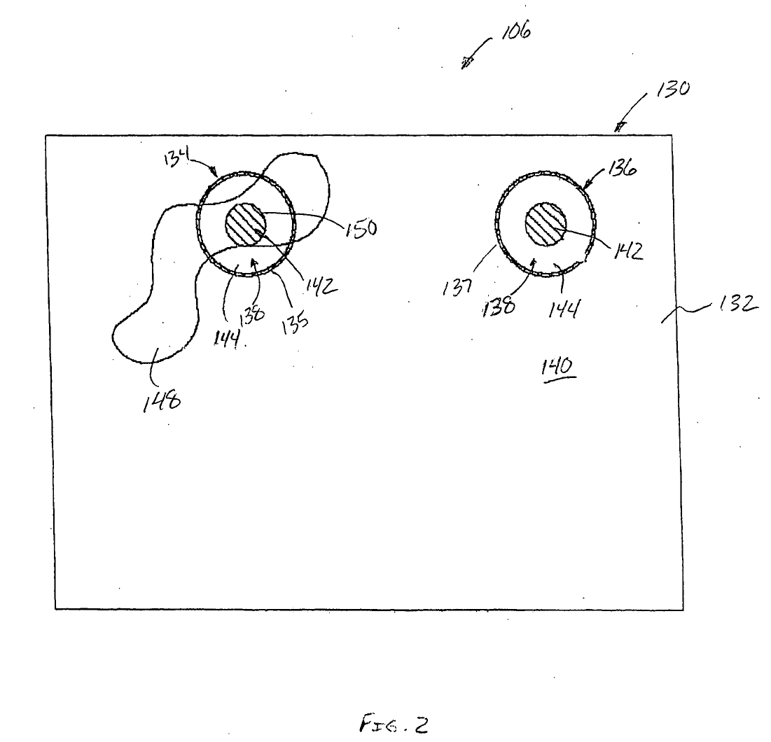

FIG. 2 is a top plan view of an exemplary control interface 106 for the control system 100 (shown in FIG. 1). The interface 106 includes a panel 130 which defines an interface area 132 for manipulation by a user to enter control commands and instructions for the device 102 (shown in FIG. 1). In different embodiments, the panel 130 may be mounted proximate the operative components 114-120 (e.g., heating elements) of the device 102 (such as in a cooking appliance), or the panel 130 may be located in a remote location from the components 114-120 (such as for moving components of an industrial machine).

The panel 130 further includes touch sensitive elements 134 and 136 (sometimes referred to as sensor element or sensors) and a periphery 135, 137 of the respective elements 134, 136 subdivide the panel interface area 132 into active areas 138 and inactive areas 140. Specifically, an area outside the peripheries 135, 137 of the elements 134, 136 constitute inactive areas 140, while an area within the peripheries constitutes the active portions or areas 138 of the sensor elements 134 and 136. The active areas 138 of the touch sensitive elements 134 and 136 include first and second sensor portions, namely a primary activation area or portion 142 and a passive secondary activation area or portion 144, sometimes referred to as a contaminant activation area, which may serve to identify inadvertent control inputs and prevent activation of a component 114-120 (shown in FIG. 1) of a device 102 as explained below. In one embodiment the primary activation area 142 and the secondary activation area 144 are discrete portions of a single touch sensitive element, and the primary and secondary activation areas 142 and 144 are calibrated to different sensitivity levels. In another embodiment, the primary and secondary activation areas 142 and 144 are defined by discrete (i.e., different) touch sensitive elements.

Each of the primary activation areas 142 and the secondary areas 144 provide inputs to the controller 104 (shown in FIG. 1), and each of the primary activation areas 142 are of a predetermined size and shape for convenient actuation with for example, a user's fingertip. The primary activation areas 142 of the respective touch sensitive elements 134 and 136 are marked with appropriate graphics or indicia to delineate the primary activation areas for the user. The secondary activation areas 144 in one embodiment are generally invisible or transparent to the user, although they may be marked or otherwise delineated if desired.

In an exemplary embodiment, the touch sensitive elements 134 and 136 are capacitive touch sensing elements such as those described in U.S. Pat. No. 5,760,715, the disclosure of which is hereby incorporated by reference in its entirety. In alternative embodiments, the touch sensitive elements 134 and 136 are known membrane switch assemblies, infrared detectors, or other known tactile or touch switches familiar to those in the art. It is understood that the touch sensitive elements 134 and 136 may be arranged in any desired orientation relative to one another within the confines of the panel 130, and greater or fewer touch sensitive elements may be employed in the panel 130 without departing from the scope of the present invention. It is further recognized that the benefits of the invention accrue to control systems having more than one control panel 130 with one or more touch sensitive elements, such as elements 134 and 136.

In use, a user touches, such as with a finger, the primary activation area 142 to enter a user command, instruction or input to the controller 104 (shown in FIG. 2), which, in turn, operates the applicable components 114-120 of the device 102 in accordance with the user input. User manipulation of the secondary or contaminant activation areas 144 will not operate the components 114-120 of the device 102. The inactive area 140 is not responsive to user touch or manipulation and is ineffective to signal the controller 104 of the control system 100 (shown in FIG. 1) in any manner. The secondary or contaminant activation areas are provided, as explained below, to appropriately address instances wherein a contaminant 148 may adversely affect the panel 130 and lead to inadvertent actuation of the device 102.

For instance, considering the case of an appliance cooktop, the contaminant 148 may be, for example, ketchup which is splashed or spilled over the control panel 130 to form an irregularly shaped mass of contaminant 148 on the surface of the panel 130. The contaminant 148 spans portions of each of the three regions or areas of the panel 130. That is, the contaminant 148 extends across a portion of the inactive area 140, a portion of the secondary activation area 144, and the primary activation area 142 of the touch sensitive element 134. The properties of the contaminant 148 may effectively extend the primary activation area 142 beyond its original periphery 150 to the portion of the secondary activation area 144 and even the portion of the inactive area 140 occupied by the contaminant 148. For example, when the touch sensitive element 134 is a capacitive touch sensor, a capacitive circuit may be completed through the ketchup to the primary activation area 142 even though a user is touching an area outside of the primary activation area. That is, an area of the panel 130 that ordinarily would not signal the controller 104 of an input instruction may nonetheless, due to the presence of the contaminant 148, activate the primary activation area 142 and signal the controller 104 to operate the device 102.

The present invention provides a system to distinguish between a true control input wherein the user actually activates one of the primary activation areas 142 of the touch sensitive elements 134 and 136 and a false control input wherein an apparent activation of the primary activation area 142 and resulting signal to the controller 104 (shown in FIG. 1) is attributable to the presence of a contaminant on the control interface 106. In an illustrative embodiment, the secondary activation areas 144 of the touch sensitive elements 134 and 136 substantially surround and are complementary in shape to the primary activation areas 142. It is anticipated, however, that the secondary activation areas 144 need not entirely surround the primary activation area 142 of the touch sensitive elements 136 or be a complementary shape to the primary activation areas 142 in alternative embodiments while still achieving at least some of the benefits of the invention.

The secondary activation areas 144 of the elements 134, 136 define a contaminant detection area proximate to or adjacent the primary activation areas 142. As explained below, the secondary activation areas 144 may be used to determine the presence of a contaminant which touches the primary activation areas 142 and causes a false input to the controller 104. By monitoring the secondary activation areas 144 in addition to the primary activation areas 142 of the touch sensitive elements 134 and 136, the controller 104 may differentiate between true and false control inputs when the primary activation area 142 signals the controller 104. Specifically, a true control input is entered only through the primary activation area 142, and a false control input is entered through both of the primary activation area 142 and the secondary activation area 144 as explained below.

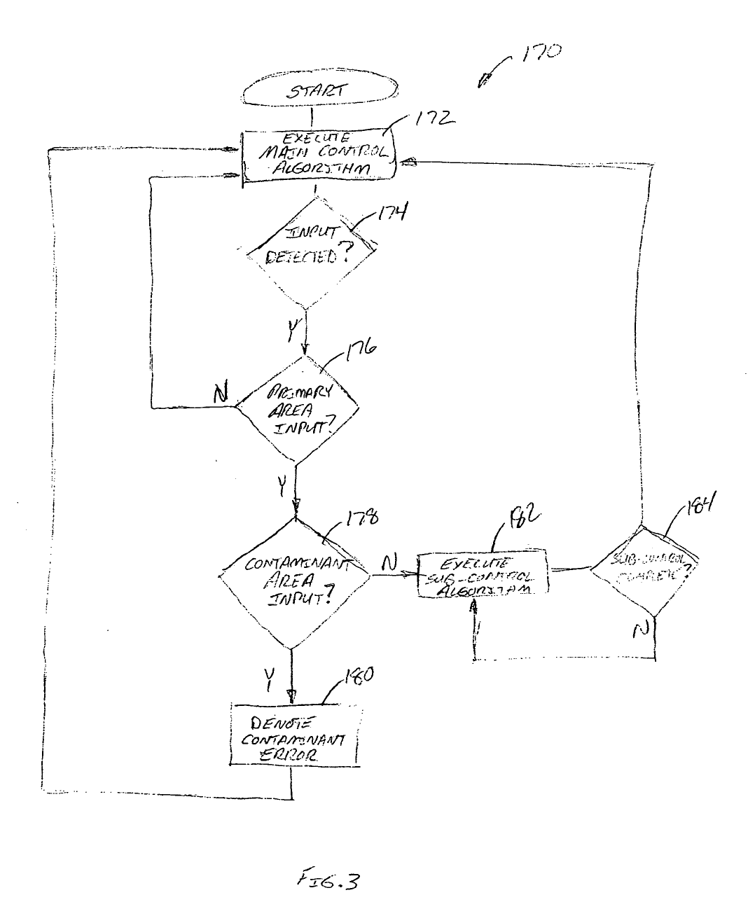

FIG. 3 is an exemplary control algorithm 170 executable, for example, by the controller 104 (shown in FIG. 1) to distinguish true and false inputs from the control interface 106 (shown in FIG. 1), and more specifically from the primary activation areas 142 of the touch sensitive elements 134 and 136 (shown in FIG. 2). By distinguishing between true and false control inputs, inadvertent actuation of the components 114-120 (shown in FIG. 1) of the device 102 (shown in FIG. 1) is prevented and only properly entered control input instructions are recognized to operate the device 102.

Upon power up of the control system 100 (shown in FIG. 1), at step 172 the controller enters a main control loop or algorithm which initializes program parameters, prepares the device for use, and then enters a dwell state awaiting user input or instruction through the control interface 106. At step 174, the controller then determines whether an input has been entered via the control interface 106, or more specifically from any of the touch sensitive elements in the interface 106, such as the elements 134 and 136. The input may be determined, for example, by scanning the touch sensitive elements 134 and 136 for inputs, awaiting a signal from the touch sensitive elements 134 and 136, or by another known method.

If an input is detected from one of the touch sensitive elements 134 or 136, then at step 176 the controller determines whether the primary activation area 142 of the respective element 134 or 136 was activated to signal the controller. If the primary activation area 142 is not activated, the controller returns to the main control algorithm and ignores the input. This scenario may occur, for example, if a user inadvertently touches the secondary containment area 144 but not the primary activation area 142. This situation may also occur due to the presence of a contaminant 148, but is considered harmless if the contaminant does not affect the primary activation area 142.

If the primary activation area 142 was activated, at step 178 the controller determines whether the secondary or contaminant area 144 of the respective touch sensitive element is also activated to signal the controller. If both the primary activation area 142 and the secondary contaminant area 144 of the respective touch sensitive element 134 or 136 are activated, an input is considered a false input possibly attributable to a contaminant 148 (shown in FIG. 2) on the panel 130 (shown in FIG. 2) of the controller interface 106, and at step 180 the controller denotes a contaminant error in, for example, the controller memory 110 (shown in FIG. 1). After denoting the error, the controller returns to the main control algorithm and awaits another input from one of the switches 134 or 136. The controller does not respond to the detected input in this circumstance wherein both the primary activation area 142 and the secondary or contaminant area 144 actuated in one of the touch sensitive elements 134 or 136.

If the primary activation area 142 was activated but the secondary contaminant area 144 was not activated, the input is considered true and at step 182 the controller enters a sub-control algorithm in response to the selected input instruction. Thus, the respective component 114-120 of the device 102 is actuated in accordance with the input instruction or command. Once the sub-control algorithm is entered, at step 184 the controller checks whether the sub-control algorithm is complete, and if so, the controller returns to the main control algorithm. If the sub-control algorithm is not complete, the controller returns to the sub-control algorithm.

Having now described the invention, it is believed that those in the art could readily adapt the teaching of the above description with appropriate modification for use in various devices to provide an appropriate safeguard against inadvertent actuation or operation device components. It is believed that the methodology of the above-described control system could be implemented without further explanation.

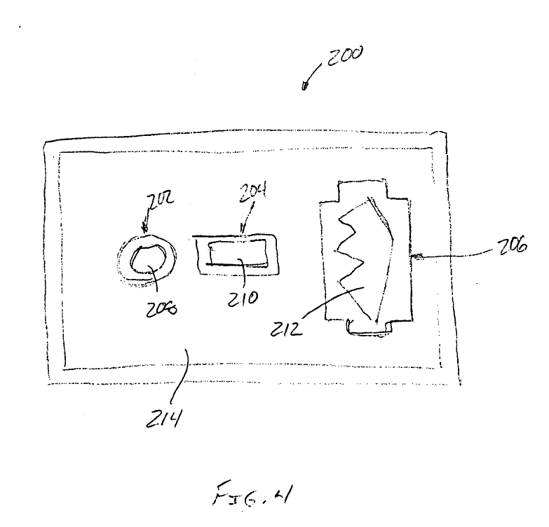

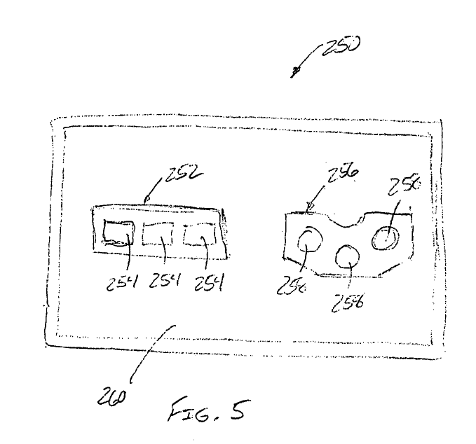

FIGS. 4 and 5 illustrate alternative embodiments of control panels 200 and 250, respectively, which may be used in lieu of the control panel 106 (shown in FIGS. 1 and 2) in the system 100 (shown in FIG. 1) to prevent inadvertent actuation of a device 102 according to the above methodology.

Control panel 200, for example, illustrates three touch sensitive elements 204, 206, and 208 of various shapes and sizes and defining primary activation areas or portions 208, 210, and 212 respectively. Each of the elements 204, 206, 208 are surrounded by a secondary contaminant detection area which encompasses each of the elements 202, 204, 206 and thereby forms a protective region around the switches which may be used to detect contaminants as described above. Thus, unlike the control panel 130 (shown in FIG. 2) which includes secondary activation areas corresponding to each of the primary activation areas of each of the touch sensitive elements, the control panel 200 employs a single contaminant detection area with a plurality of touch sensitive elements 202, 204, and 206.

As noted above, the secondary activation area 214 may be defined by the same or different touch sensitive elements as the primary activation areas 208, 210, 212.

In the control panel 250 of FIG. 5, a first touch sensitive element 252 includes multiple primary activation areas 254, and a second touch sensitive element 256 includes multiple primary activation areas 258. The touch sensitive elements 252 and 256 and the respective primary activation areas 254 and 258 are surrounded by a contaminant detection area 260. The secondary contamination detection area 260 may be defined by the same or different touch sensitive elements as the elements 252 and 256.

While the invention has been described in terms of various specific embodiments, those skilled in the art will recognize that the invention can be practiced with modification within the spirit and scope of the claims.

What is claimed is:

1. A touch sensitive control interface for a controlled device, said control interface comprising:
a panel defining an interface area configured to selectively input command instructions of an operator of the device; said panel comprising at least one primary touch sensor portion configured to receive a true operator command, and a secondary touch sensor portion proximate said primary touch sensor portion, said secondary touch sensor portion configured to detect a false operator command due to a presence of a contaminant.

2. An interface in accordance with claim 1 wherein said primary touch sensor portion is substantially circular.

3. An interface in accordance with claim 1 wherein said secondary touch sensor portion substantially surrounds said primary touch sensor portion.

4. An interface in accordance with claim 1 further comprising a first touch sensitive element defining said primary sensor portion and a second touch sensitive element defining said secondary touch sensor portion.

5. An interface in accordance with claim 1 wherein said primary touch sensor portion and said secondary touch sensor portion are defined by a single touch sensitive element.

6. An interface in accordance with claim 1 wherein said at least one primary touch sensor portion is defined by a capacitive sensor.

7. An interface in accordance with claim 1 further comprising a plurality of primary touch sensor portions extending on said panel, and a plurality of secondary touch sensor portions, each contaminant detection area proximate a respective one of said primary detection areas.

8. An interface in accordance with claim 1 wherein activation of said secondary touch sensor portion prevents actuation of said device.

9. An interface in accordance with claim 1 wherein said panel comprises a plurality of primary touch sensor portions, said secondary touch sensor portion substantially surrounding more than one of said primary touch sensor portions.

10. A touch sensitive control interface comprising a plurality of touch sensitive areas configured to accept a user input, at least one of said touch sensitive areas comprising a primary activation area and a contaminant detection area surrounding said primary activation area.

11. An interface in accordance with claim 10 wherein said primary activation area comprises a curved outer perimeter.

12. An interface in accordance with claim 10 wherein said contaminant detection area is complementary in shape to said primary activation area.

13. An interface in accordance with claim 10 wherein said at least one touch sensitive area comprises a first touch sensitive element defining said primary activation area and a second touch sensitive element defining said contaminant detection area.

14. An interface in accordance with claim 10 wherein said at least one touch sensitive area comprises a single touch sensitive element defining said primary activation area with a first level of touch sensitivity and defining said contaminant detection area with a second level of touch sensitivity.

15. An interface in accordance with claim 10 wherein said at least one touch sensitive area is defined by a capacitive sensor.

16. An interface in accordance with claim 10 further comprising a plurality of primary activation areas, said contaminant detection area serving more than one of said plurality of primary activation areas.

17. A touch sensitive control system for controlling a device, said control system comprising:
an interface comprising at least one predefined primary touch sensitive area and a contaminant detection area adjacent said activation area; and
a controller electrically connected to said interface and operatively responsive to said interface when said primary touch sensitive area is activated and when said contaminant detection area is not activated, said controller programmed to prevent actuation of the device when said contaminant detection area is activated, regardless of the state of said primary activation area.

18. A control system in accordance with claim 17 wherein said primary touch sensitive area and said contaminant detection area are substantially contiguous.

19. A control system in accordance with claim 17 wherein said contaminant detection area extends radially from said primary touch sensitive area.

20. A control system in accordance with claim 17 wherein said contaminant detection area substantially surrounds said primary touch sensitive area.

21. A control system in accordance with claim 17 said primary touch sensitive area is defined by a first touch sensitive element and said contaminant detection area is defined by a second touch sensitive element.

22. A control system in accordance with claim 17 wherein said primary touch sensitive area and said contaminant detection area are defined by a single touch sensitive element.

23. A control system in accordance with claim 17 wherein said at least one primary touch sensitive area comprises a capacitive sensor.
